(19) United States
(12) Patent Application Publication
(10) Pub. No.: US 2010/0186677 A1
(43) Pub. Date: Jul. 29, 2010

(54) POULTRY MANURE SKIMMER

(76) Inventor: DAVID L. DICK, SCHALLER, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 12/361,630

(22) Filed: Jan. 29, 2009

(51) Int. Cl. A01K 1/01

(52) U.S. Cl. 119/442

(57) ABSTRACT

A method and apparatus for sorting and removing waste from a poultry house is described. The apparatus sorts and deposits waste litter to a central location where it is then cleared using a separate machine.

### BACKGROUND OF THE INVENTION

When raising turkeys, it is important to keep them in an enclosed area to prevent them from wondering off or being killed by predators. These enclosures are typically referred to as a poultry house and average 50 feet wide and 600 feet long. The poultry house confines the turkeys and provides protection against the elements.

One concern in caring for turkeys in these poultry houses is the need to regularly remove waste. The floor of a poultry house is often covered with litter which receives and absorbs the turkey waste. As the litter absorbs the waste, the waste tends to stick together, making it easy to separate from the dry litter and remove. One method of removing the waste from the dry litter is by a sifting means. The waste is collected and passed over a grating or slotted surface. The dry litter falls through the grating back to the floor of the poultry house while the solid waste is retained and is then disposed of. This process is known as skimming.

Prior art machines automate this process by utilizing a slotted conveyor or lift system which deposits the solid waste into a box or crate. The box or crate is connected to the lift and must be emptied once it is full. This requires leaving the poultry house to dump the waste and returning to continue the skimming, a time consuming process. Therefore, it is an object of this invention to provide a method for sorting waste from dry litter and eliminating the need to collect and empty waste from a storage container.

It is a further object of this invention to provide an apparatus and method for delivering waste material to a preferred location in the poultry house for removal after the entire house has been skimmed.

### BRIEF SUMMARY OF THE INVENTION

The present invention is directed to an improved method and apparatus for removing waste litter from a poultry house.

According to one embodiment of the present invention, waste litter is sifted and directed to a central location within the poultry house by a conveyor system for later removal by the operator.

### BRIEF DESCRIPTION OF THE DRAWINGS

FIG. 1 shows a side view of the invention.

FIG. 2A shows a perspective view of the beater.

FIG. 2B shows a front view of the sorter.

FIG. 2C shows a top view of the lift.

FIG. 3A shows the pivot point for the conveyor.

FIG. 3B shows an enlarged view of the receiver on the conveyor.

### DETAILED DESCRIPTION OF THE PREFERRED EMBODIMENT

The invention generally comprises two parts. First, a sorter 20 having a beater 22 and a lift 30 for separating the litter 70 into waste 74 and dry litter 76. Second, a conveyor 40 for receiving the waste 74 from the sorter 20 and delivering it to a center aisle 66 in the poultry house 60.

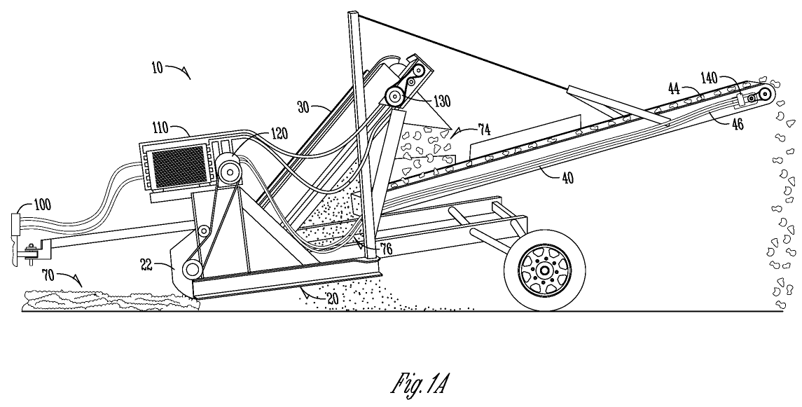

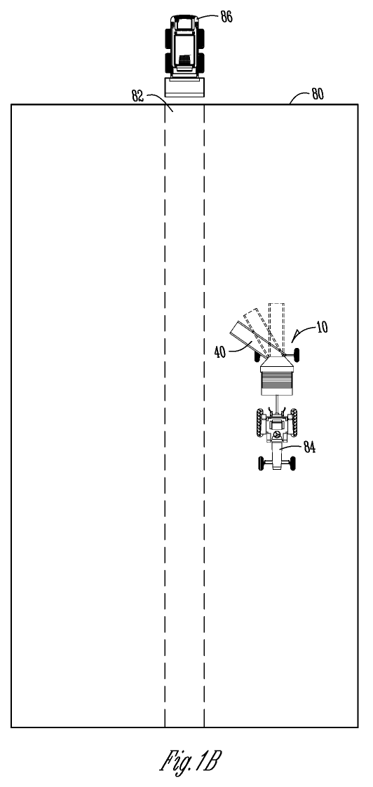

The entire apparatus is shown in FIG. 1. The litter 70 is passed into the beater 22 of the sorter 20, the beater 22 breaks up large clumps of litter 70. The litter 70 is then passed into the lift 30 which allows dry litter 76 to fall through to the floor of the poultry house. The waste 74 is lifted by the lifter 30 and deposited onto the conveyor 40. The litter is then transported along the belt 44 and deposited to a preferred location in the poultry house.

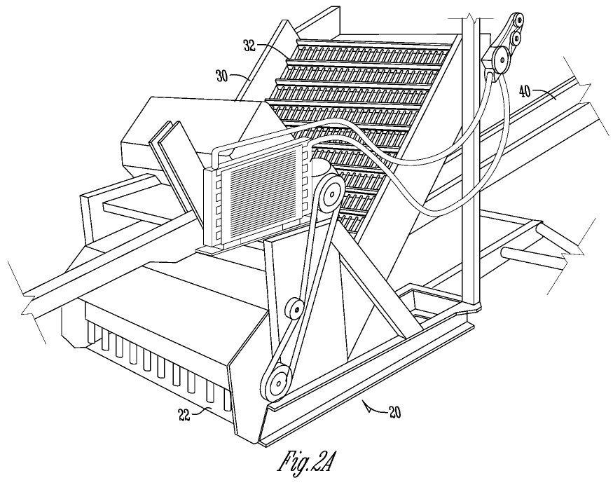

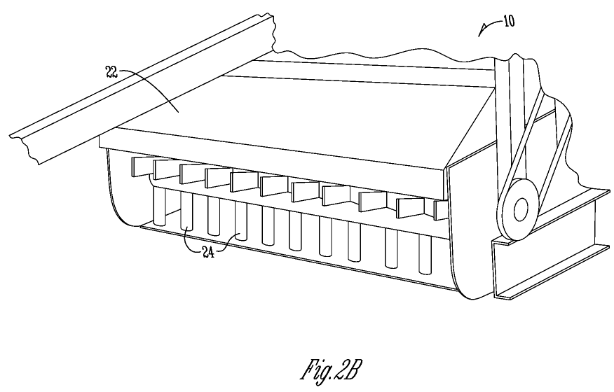

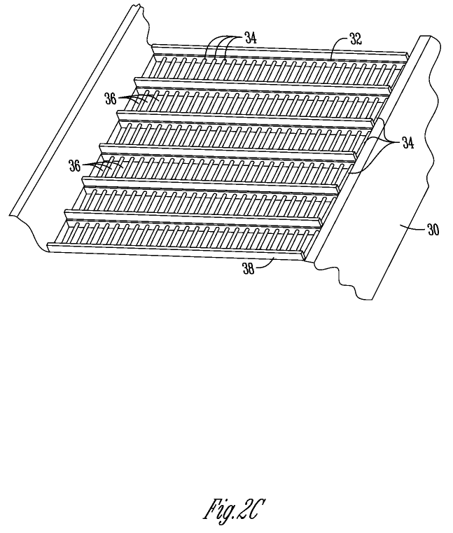

FIG. 2A generally shows the sorter 20. The sorter 20 comprises a beater 22 for breaking up the clumps of litter and a lift 30 for separating dry litter from waste and delivering the waste to the conveyor 40.

FIG. 2B generally shows the beater 22. The beater 22 comprises a series of blades 24 disposed about a rotating drum or axis. The blades 24 spin during operation in order to break up large clumps of litter. While rotating blades are preferred, other means for breaking up litter may be used, including oscillating fingers or other devices known in the mechanical arts.

FIG. 2C shows the belt 32 of the lift 30. As shown, the belt 32 comprises a series of panels 34, the panels 34 hinged together about their long edges 32 so as to form a continuous loop and each has a number of slots 36. The slots 36 are sized and spaced so that dry litter falls through, but not waste. The belt 32 is attached to a motor which advances the belt 32, causing the raised edges of the long edge 32 to carry waste as it is sifted. As the unsoiled dry litter falls back to the floor of the poultry house, the waste is carried over the lift 30 and deposited onto the conveyor.

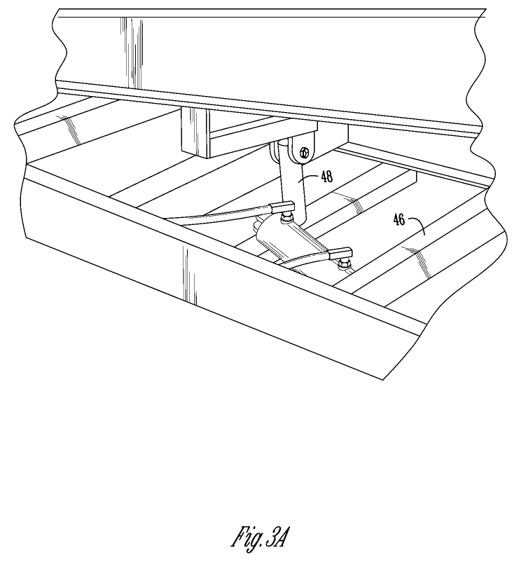

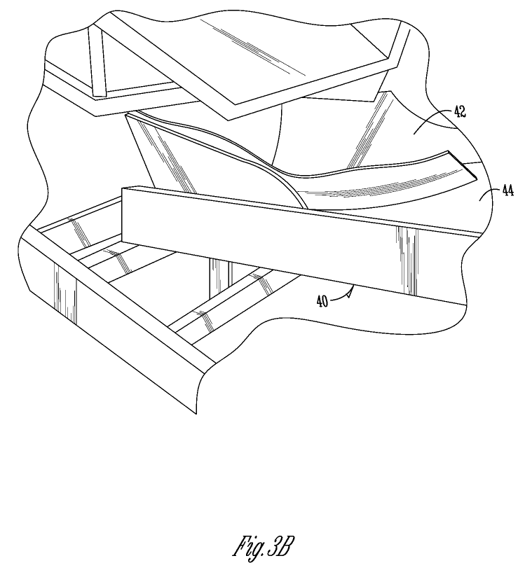

The conveyor as shown in FIG. 1 generally comprises a frame 46 holding a belt 44 and a shield 42 (see FIG. 3A) about one end of the belt 44. The shield 42 prevents waste from falling off of the conveyor belt 40 as it is deposited from the lift 30. The conveyor 40 is also preferably mounted onto a pivot 48, as shown as FIG. 3B, the pivot 48 being adapted to adjust the angle of the conveyor 40 to deposit the waste 74 to a preferred location. FIG. 3B shows the shield 42 as generally enclosing the sides of one end of the conveyor 40, however, other arrangements are anticipated as well. The shield 42 is designed so that the conveyor 40 may pivot and the shield remains positioned so as to catch waste 74 from the lift 30.

The conveyor 40 is preferably powered by pressurized hydraulic fluid, the pressurized hydraulic fluid supplied by a power takeoff (PTO) pump attached to the drive train of a tractor. The same tractor may be used to pull the sorter-conveyor system. While this is one preferred means of powering the conveyor 40, other power sources, such as electrical or pneumatic power, may be used as can be appreciated by those skilled in the art.

As can be seen in FIG. 1, the PTO 100 pressurizes fluid which is used to drive a first motor 120 for the beater 22, a second motor 130 for the lift 30 and a third motor 140 for the conveyor 140. An air cooler 110 is also included to cool the hydraulic fluid.

The invention also describes a method of using the above-described apparatus for clearing a poultry house of waste. Poultry houses are generally of a length of 600 feet, and a width of 50 feet. While poultry house designs may vary, generally the length dimension is significantly larger than the width dimension. During operation, several passes of the sorter-conveyor system 10 are required in order to completely skim the litter to separate waste from dry litter.

According to the preferred method, a center aisle is designated in the poultry house. The sorter-conveyor system 10 is attached to a tractor. The conveyor 40 is pivoted about the pivot 48 so that waste exits the conveyor 40 and is deposited in the center aisle. After each pass of the length of poultry house, the conveyor 40 is repositioned so that waste is distributed along the center aisle of the poultry house. After a number of passes have been made so as to completely skim all of the litter of the poultry house, all of the waste is deposited throughout the center aisle of the poultry house. At this point, a front end loader or other moving device is used to remove the litter from the center aisle.

The above-described invention provides a significant advantage over the prior art. According to prior sifting models, the waste is deposited into a box, and the box emptied after it is filled. This represents significant lost time as well as energy. The above-described method and apparatus significantly improve the efficiency of clearing a poultry house of waste while retaining unsoiled litter within the poultry house.

The above-described invention is exemplary and other variations of the invention may be appreciated by those skilled in the art. Any limitations of the present invention appear in the claims.

What is claimed is:

1. A method for removing waste from litter in a poultry house comprising the steps of:
collecting litter;
passing the litter through a beater adapted to break up large pieces of litter;
lifting the litter on a conveyor belt, the conveyor belt having a plurality of slots designed so as to allow clean litter to pass through and soiled litter to remain;
passing the litter onto a second conveyor belt, the conveyor belt being angled so as to deliver the soiled litter to a preferred location within the poultry house.

2. The method of claim 1 further comprising the step of performing multiple passes through the poultry house.

3. The method of claim 2 wherein the preferred location comprises a central aisle.

4. The method of claim 3 further comprising the step of positioning the second conveyor belt to deliver the soiled litter to the central aisle.

5. The method of claim 4 further comprising the step of repositioning the second conveyor belt after each successive pass.

6. The method of claim 5 further comprising the step of removing the soiled litter from the poultry house after all passes have been completed.

7. An apparatus for removing waste from litter in a poultry house, the apparatus comprising:
a beater assembly having means for breaking up clumps of solid litter;
a first conveyor belt adapted to receive the litter from the beater assembly and sort waste from dry litter;
a second conveyor belt positioned so that waste from the first conveyor belt falls thereon, the second conveyor belt being positionable so as to deliver the waste to a predetermined position.

8. The apparatus of claim 7 wherein the first conveyor belt comprises a plurality of slots which allow unsoiled litter to pass through while retaining soiled litter.

9. The apparatus of claim 8 wherein the second conveyor belt is adapted to pivot about a point.

10. The apparatus of claim 7 further comprising a transport means.

11. The apparatus of claim 10 wherein the predetermined position comprises a central aisle of the poultry house.

12. The apparatus of claim 11 further comprising a hydraulic power source.

13. The apparatus of claim 12 wherein the hydraulic power source controls the first and second conveyor belts.

14. The apparatus of claim 13 wherein the hydraulic power source is operably connected to the transport means.
